(19) United States
(12) Patent Application Publication
(10) Pub. No.: US 2024/0317315 A1
(43) Pub. Date: Sep. 26, 2024

(54) VEHICLE-BODY LOWER STRUCTURE

(71) Applicant: SUBARU CORPORATION, Tokyo (JP)

(72) Inventor: Ryousuke ASAKA, Tokyo (JP)

(21) Appl. No.: 18/600,260

(22) Filed: Mar. 8, 2024

(30) Foreign Application Priority Data
Mar. 23, 2023 (JP) 2023-046911

(51) Int. Cl. B62D 21/15

(52) U.S. Cl. CPC B62D 21/157

(57) ABSTRACT

A vehicle-body lower structure includes a cross member body and a reinforcement. The cross member body is provided on an upper surface of a floor panel of a vehicle body of a vehicle and extends in a vehicle width direction of the vehicle. The reinforcement extends along the cross member body in a partial region of the cross member body in the vehicle width direction. The cross member body has a bead extending in a direction intersecting the vehicle width direction in a vehicle-widthwise intermediate position within the partial region in which the reinforcement extends.

### CROSS-REFERENCE TO RELATED APPLICATIONS

The present application claims priority from Japanese Patent Application No. 2023-046911 filed on Mar. 23, 2023, the entire contents of which are hereby incorporated by reference.

### BACKGROUND

The disclosure relates to a vehicle-body lower structure including a cross member provided on an upper surface of a floor panel and a reinforcement disposed on the cross member.

Conventionally, a vehicle-body lower part of a vehicle such as an automobile includes a floor panel forming a floor of a vehicle body and side sills extending in a vehicle body front-rear direction on vehicle-widthwise opposite sides of the floor panel. For example, the floor panel has, at its vehicle-widthwise central part, a floor tunnel protruding in a vehicle body upward direction from the floor panel and extending in the vehicle body front-rear direction.

For example, left and right cross members are provided extending in the vehicle width direction from the floor tunnel to the side sills on the vehicle-widthwise opposite sides of the floor panel. Each of the cross members is generally molded by press molding a sheet metal member into a substantially hat-shaped cross section. The cross member molded as described above is provided on the upper surface of the floor panel.

The cross member absorbs a collision load at the time of a side-face collision (hereinafter, referred to as a “side collision”) of the vehicle. Accordingly, the cross member reduces entry of a door or the like into a vehicle interior due to a deformation of a vehicle-body side part at the time of the side collision of the vehicle. Thus, the cross member is sought to have proof stress for absorbing the collision load.

Conventionally, various techniques have been proposed as a vehicle-body lower structure for improving proof stress of a cross member in the event of such a side collision of a vehicle. For example, Japanese Patent No. 5544654 discloses a cross member structure including a pair of lateral beads formed in a vehicle width direction on a front wall surface or a rear wall surface of a cross member and disposed at a predetermined interval therebetween in a vehicle body up-down direction, and a coupling bead coupling vehicle-widthwise outer ends of the pair of lateral beads. Such a cross member can increase buckling proof stress. Thus, the cross member disclosed in Japanese Patent No. 5544654 has a structure capable of absorbing a collision load through crushing of the cross member without buckling when a collision object collides laterally with the cross member over a wide region as in a barrier side collision (side collision with a bumper or the like of another vehicle).

### SUMMARY

An aspect of the disclosure provides a vehicle-body lower structure. The vehicle-body lower structure includes a cross member body and a reinforcement. The cross member body is provided on an upper surface of a floor panel of a vehicle body of a vehicle and extends in a vehicle width direction of the vehicle. The reinforcement extends along the cross member body in a partial region of the cross member body in the vehicle width direction. The cross member body has a bead extending in a direction intersecting the vehicle width direction in a vehicle-widthwise intermediate position within the partial region in which the reinforcement extends.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view illustrating a frame structure of a vehicle-body lower part;

FIG. 2 is a plan view illustrating the frame structure of the vehicle-body lower part;

FIG. 3 is an enlarged perspective view illustrating a frame structure on a left side of the vehicle-body lower part;

FIG. 4 is a cross-sectional view taken along line IV-IV of FIG. 3;

FIG. 5 is an exploded perspective view of a second cross member on the left side of the vehicle-body lower part;

FIG. 6 is a cross-sectional view taken along line VI-VI of FIG. 3;

FIG. 7 is a cross-sectional view taken along line VII-VII of FIG. 3;

FIG. 8 is a plan view illustrating a deformed state of the frame structure at the time of a barrier side collision; and

FIG. 9 is a plan view illustrating a deformed state of the frame structure at the time of a pole side collision.

### DETAILED DESCRIPTION

The technique disclosed in Japanese Patent No. 5544654 described above may involve difficulty in absorbing a sufficient collision load with respect to a locally large collision load. For example, when a locally large collision load is input in front of the cross member upon a pole side collision with the vehicle body (side collision with a pole object such as a utility pole), it may be difficult to exhibit sufficient absorption of the collision load through crushing of the cross member. In this case, the cross member may buckle before sufficiently crushing unlike at the time of the barrier side collision. Thus, the cross member may not be able to sufficiently reduce the deformation of the vehicle-body side part.

It is desirable to provide a vehicle-body lower structure that can protect an occupant from a deformation of a vehicle-body side part by controlling a deformation of a cross member against both a barrier side collision and a pole side collision.

Hereinafter, an embodiment of the disclosure will be described with reference to the drawings.

Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

As an example of application of the vehicle-body lower structure according to the present embodiment, a configuration of a vehicle-body lower part of an automobile will be described. Note that, the “join” described in the following description means any joining method performed using a joining technique represented by melt joining, mechanical joining, or the like.

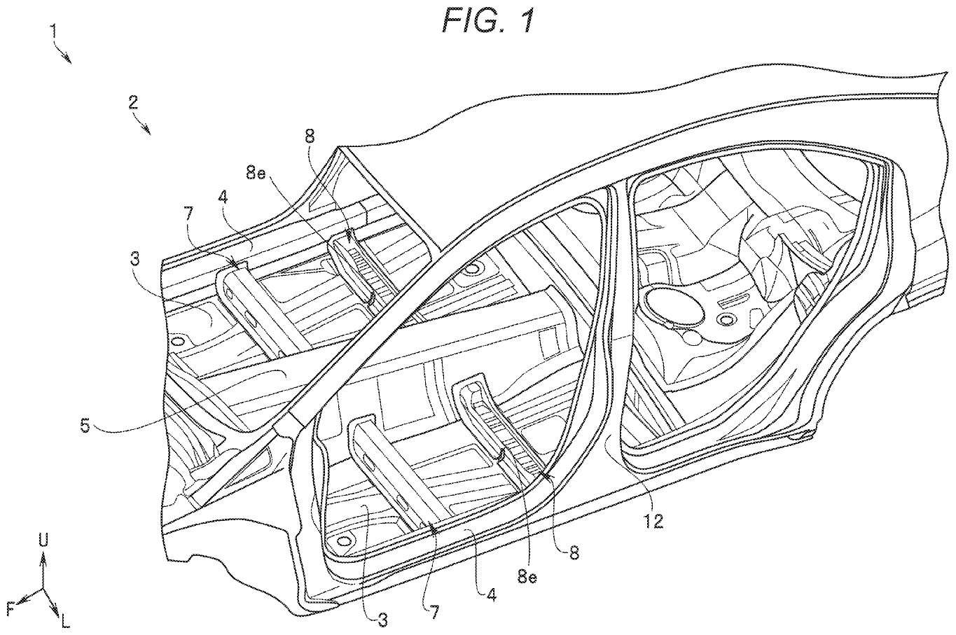

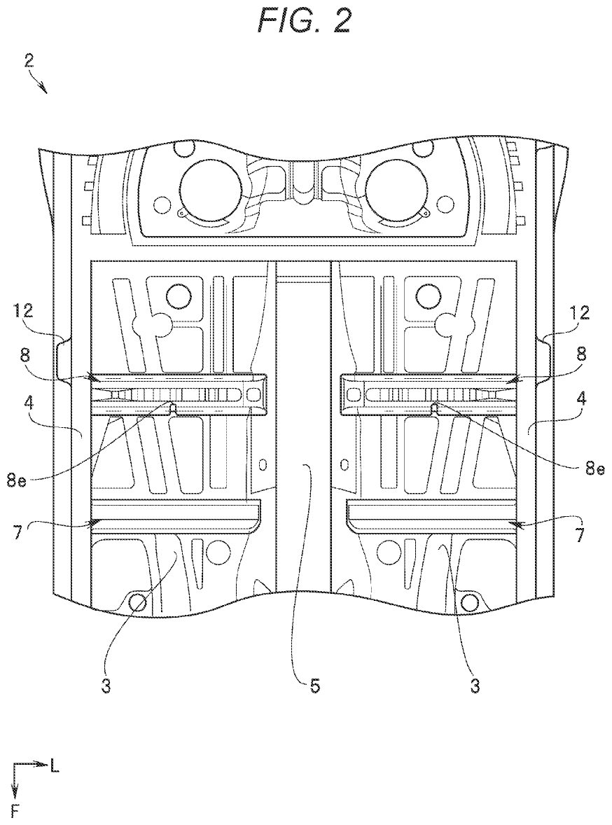

As illustrated in FIGS. 1 and 2, a lower part of a vehicle body 2 of a vehicle 1 includes, for example, a floor panel 3 and a pair of side sills 4.

The floor panel 3 forms a floor of the vehicle body 2. The floor panel 3 has, at its vehicle-widthwise central part, a floor tunnel 5.

The side sills 4 extend in a vehicle body front-rear direction on vehicle-widthwise opposite sides of the floor panel 3.

The floor panel 3 and each side sill 4 are generally formed by pressing a sheet metal member made of a high-strength steel plate or the like.

In the vehicle-body lower part configured as described above, cross members 7 and 8 are provided on both left and right sides of the floor tunnel 5. In one example, a first cross member 7 and a second cross member 8 are provided on each of the left and right sides of the floor tunnel 5. The basic structures of the floor tunnel 5 on the vehicle-widthwise outer sides are bilaterally symmetrical. Thus, in the following description, a left part of the vehicle body will be described as an example.

For example, the first cross member 7 is provided between the side sill 4 and the floor tunnel 5 on an upper surface of the floor panel 3. The first cross member 7 is disposed on a front side of the vehicle body. For example, the first cross member 7 is formed by press molding a sheet metal member made of a high-strength steel plate.

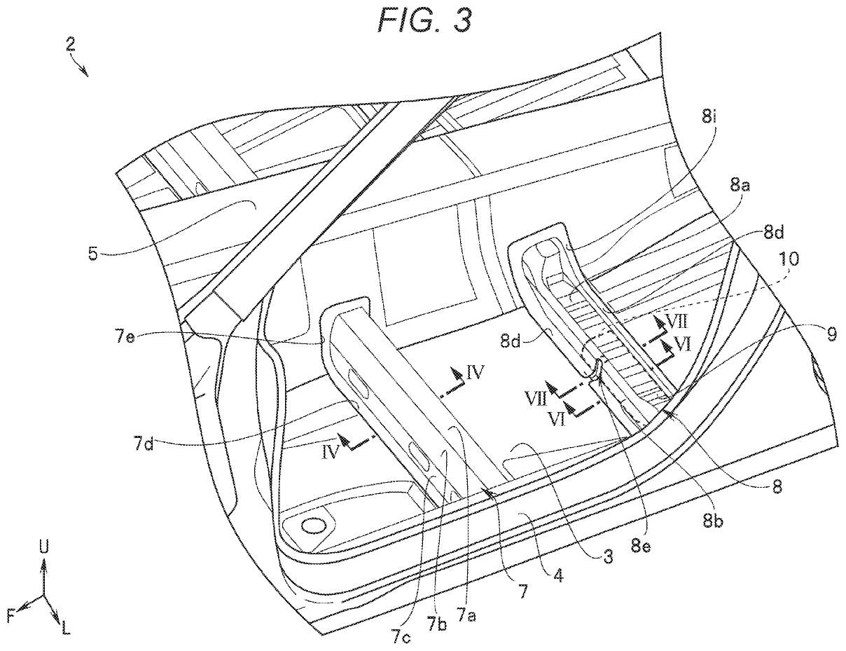

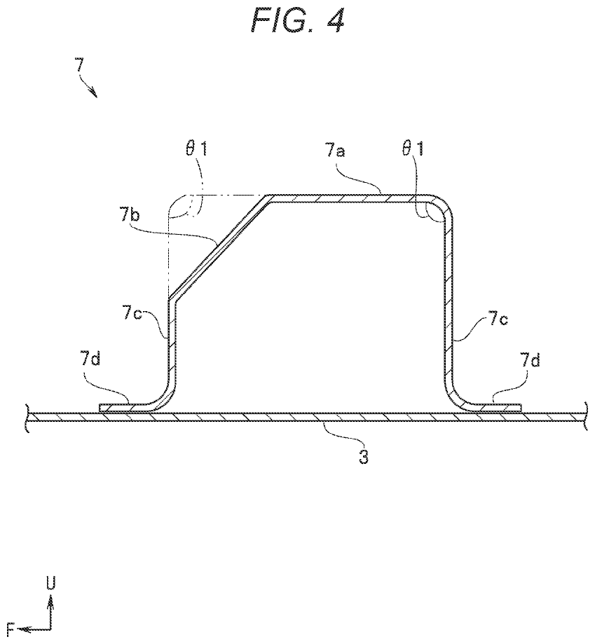

In one example, as illustrated in FIGS. 3 and 4, the first cross member 7 includes a top plate 7a, an inclined wall 7b, a pair of vertical walls 7c, and a pair of flanges 7d.

The top plate 7a is disposed in a position facing the upper side of the floor panel 3.

The inclined wall 7b incliningly extends obliquely downward forward from a front edge of the top plate 7a toward the floor panel 3.

The vertical walls 7c extend downward from a lower end of the inclined wall 7b and a rear edge of the top plate 7a.

The flanges 7d extend in the vehicle body front-rear direction from respective lower ends of the vertical walls 7c.

Thus, a cross section of the first cross member 7 taken along the vehicle body front-rear direction has a substantially hat shape having the inclined surface on a part of the front side of the vehicle body (see FIG. 4).

An angle θ1 formed by the top plate 7a and each of the vertical walls 7c is set to approximately 90 degrees or a slightly obtuse angle.

As illustrated in FIG. 3, the first cross member 7 further includes, at its vehicle-widthwise opposite end edges, a pair of flanges 7e.

The first cross member 7 configured as described above is joined to the vehicle body 2 at each flange 7d and each flange 7e.

That is, the first cross member 7 is joined to the upper surface of the floor panel 3 at the flanges 7d extending in the front-rear direction. Accordingly, the cross section formed by the first cross member 7 and the floor panel 3 has a closed cross-sectional shape. The first cross member 7 is joined, at the flanges 7e formed at the vehicle-widthwise opposite end edges of the first cross member 7, to a vehicle-widthwise inner side surface of the side sill 4 and a vehicle-widthwise outer side surface of the floor tunnel 5.

With such a configuration, the first cross member 7 can reduce the deformations of the floor panel 3 and the side sill 4 when a collision load is input from the vehicle-body side part.

For example, the second cross member 8 is provided between the side sill 4 and the floor tunnel 5 on the upper surface of the floor panel 3. In addition, as illustrated in FIGS. 2 and 3, the second cross member 8 is disposed behind the first cross member 7. Furthermore, the second cross member 8 is disposed in a position inside a center pillar 12 in the vehicle width direction and partially overlapping the front part of the center pillar 12 in the vehicle body front-rear direction. The second cross member 8 includes a cross member body 9 and a reinforcement 10.

For example, the cross member body 9 is formed by press molding a sheet metal member made of a high-strength steel plate. By this molding, the cross member body 9 has a basic shape having a substantially hat-shaped cross section.

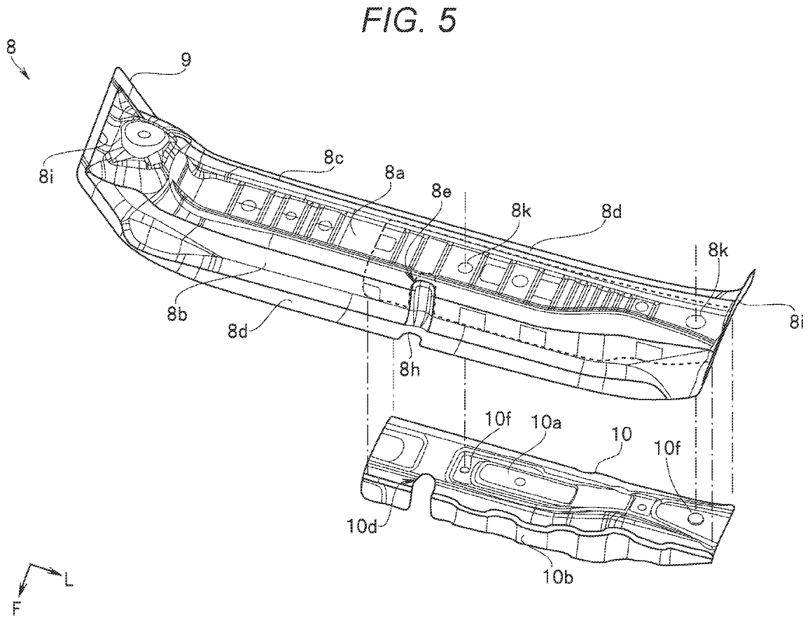

In one example, as illustrated in FIGS. 5, 6, and 7, the cross member body 9 includes a top plate 8a, a front vertical wall 8b, a rear vertical wall 8c, and a pair of flanges 8d.

The top plate 8a is disposed in a position facing the upper side of the floor panel 3. The top plate 8a has holes 8k through which protrusions 10f for positioning the reinforcement 10 which will be described later are inserted (see FIG. 5).

The front vertical wall 8b and the rear vertical wall 8c extend downward from a front edge and a rear edge of the top plate 8a, respectively.

The flanges 8d extend in the vehicle body front-rear direction from respective lower ends of the front vertical wall 8b and the rear vertical wall 8c.

An angle θ2 formed by the top plate 8a and each of the front vertical wall 8b and the rear vertical wall 8c is set to be approximately 90 degrees or a slightly obtuse angle.

The cross member body 9 having such a basic shape has a bead 8e for crushing the front vertical wall 8b inward in the vehicle width direction when a collision load is input from the vehicle-body side part.

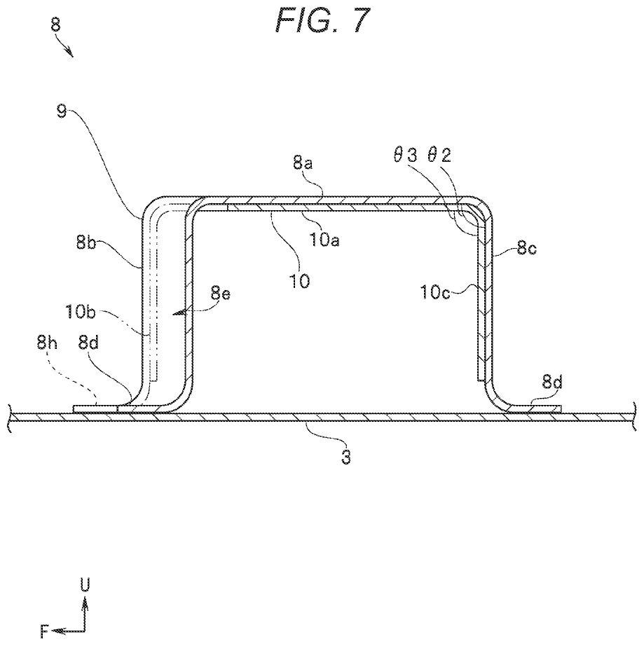

For example, as illustrated in FIGS. 5 and 7, the bead 8e is provided in a vehicle-widthwise intermediate position of the front vertical wall 8b. The bead 8e extends in a direction (vehicle body up-down direction) intersecting the vehicle width direction of the front vertical wall 8b. The bead 8e has a shape recessed from the front vertical wall 8b toward the rear side of the vehicle body.

In one example, the bead 8e is provided substantially at the center of the front vertical wall 8b in the vehicle width direction. The bead 8e is formed of, for example, a recessed groove having a substantially U-shaped cross section. That is, the bead 8e has a curved shape without any intermediate bent part.

The flange 8d has a cutout 8h at a position corresponding to the bead 8e.

The cutout 8h has, for example, a substantially U shape from the front edge of the flange 8d toward the lower end of the bead 8e. That is, the cutout 8h has a curved shape without any intermediate bent part.

With such a configuration, when a collision load is input, the bead 8e serves as a starting point of the deformation for crushing the front vertical wall 8b inward in the vehicle width direction.

In order to accurately crush the front vertical wall 8b at a predetermined position when a collision load equal to or greater than a predetermined value is input, various conditions such as the arrangement of the bead 8e, the width of the bead 8e, the height of the bead 8e, and the depth of the bead 8e are obtained in advance by experiments, simulations, and the like.

As illustrated in FIGS. 3 and 5, the cross member body 9 configured as described above includes, at its vehicle-widthwise opposite end edges, a pair of flanges 8i.

The flanges 8i are continuous with the respective flanges 8d extending in the vehicle width direction.

The cross member body 9 is joined to the vehicle body 2 at each flange 8d and each flange 8i.

That is, the cross member body 9 is joined to the upper surface of the floor panel 3 at the flanges 8d extending in the front-rear direction. Accordingly, the cross section formed by the cross member body 9 and the floor panel 3 has a closed cross-sectional shape. The cross member body 9 is joined, at the flanges 8i formed at the vehicle-widthwise opposite end edges of the cross member body 9, to the vehicle-widthwise inner side surface of the side sill 4 and the vehicle-widthwise outer side surface of the floor tunnel 5.

Within the closed cross section formed by the cross member body 9 and the floor panel 3 as described above, the reinforcement 10 for reinforcing the second cross member 8 at the time of the side collision is disposed. The reinforcement 10 extends in a partial region of the cross member body 9 in the vehicle width direction.

In one example, as illustrated in FIG. 5, the reinforcement 10 extends in the vehicle width direction along the cross member body 9. The reinforcement 10 is disposed in a vehicle-widthwise outer region of the cross member body 9.

Here, the region in which the reinforcement 10 is disposed is set to a region including the bead 8e formed on the cross member body 9. That is, for example, the vehicle-widthwise outer end of the region in which the reinforcement 10 is disposed is set at a position substantially coinciding with the vehicle-widthwise outer end of the cross member body 9. A vehicle-widthwise inner end of the region in which the reinforcement 10 is disposed is set at a position on the inner side in the vehicle width direction with respect to the bead 8e.

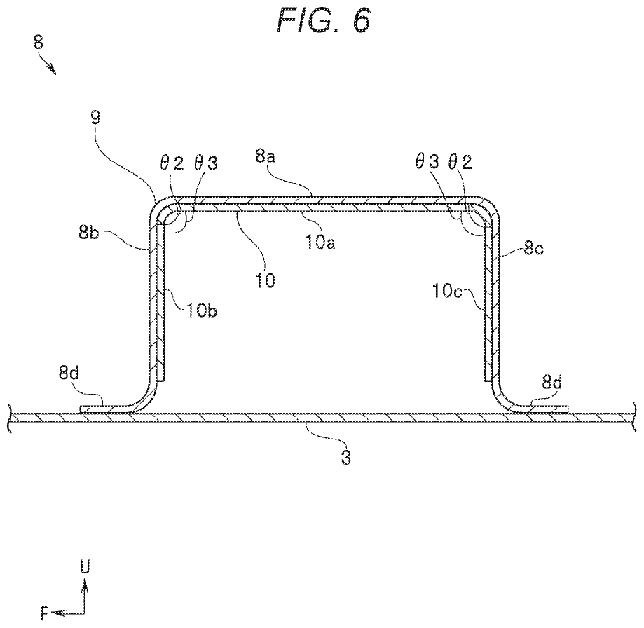

For example, the reinforcement 10 disposed as described above is formed by press molding a sheet metal member made of a high-strength steel plate. By this molding, as illustrated in FIG. 6, the reinforcement 10 has a basic shape including a top plate 10a, a front vertical wall 10b, and a rear vertical wall 10c.

The top plate 10a extends along the inner surface of the top plate 8a of the cross member body 9. The top plate 10a has the protrusions 10f for positioning the reinforcement 10 with respect to the cross member body 9 (see FIG. 5). The protrusions 10f are provided at positions corresponding to the holes 8k of the cross member body 9.

The front vertical wall 10b and the rear vertical wall 10c extend downward from the front edge and the rear edge of the top plate 10a, respectively.

For example, an angle θ3 formed by the top plate 10a and each of the front vertical wall 10b and the rear vertical wall 10c is set to be substantially equal to the angle θ2. As a result, the outer surface of the reinforcement 10 has a shape that can be brought into surface contact with the inner surface of the cross member body 9. That is, the outer surface of the top plate 10a of the reinforcement 10 can be brought into surface contact with the inner surface of the top plate 8a of the cross member body 9. The outer surfaces of the front vertical wall 10b and the rear vertical wall 10c of the reinforcement 10 can respectively be brought into surface contact with the inner surfaces of the front vertical wall 8b and the rear vertical wall 8c of the cross member body 9.

The reinforcement 10 having such a basic shape has a cutout 10d in a vehicle-widthwise intermediate position of the front vertical wall 10b. As illustrated in FIG. 5, the cutout 10d is provided at a position corresponding to the bead 8e of the cross member body 9.

In one example, as illustrated in FIGS. 5 and 7, for example, the cutout 10d extends in the up-down direction. The cutout 10d has a lower end opened. The cutout 10d further has an upper end extending to a part of the top plate 10a. The upper end of the cutout 10d extending as described above has a substantially U shape from a front vertical wall 10b side toward the rear side of the top plate 10a. That is, the upper end of the cutout 10d has a curved shape without any intermediate bent part.

The cutout 10d has dimensions of a width, and a length (depth) toward the rear side that are set slightly larger than dimensions of the bead 8e.

The reinforcement 10 configured as described above is joined to the cross member body 9 in a state of being in contact with the cross member body 9 from below.

At this time, the reinforcement 10 is positioned with respect to the cross member body 9 through the protrusions 10f. That is, the protrusions 10f are inserted through the holes 8k of the cross member body 9 from below, thus achieving positioning of the reinforcement 10 with respect to the cross member body 9. The top plate 10a, the front vertical wall 10b, and the rear vertical wall 10c of the reinforcement 10 positioned as described above are joined in a state of being in surface contact with the top plate 8a, the front vertical wall 8b, and the rear vertical wall 8c of the cross member body 9, respectively. Accordingly, the reinforcement 10 is firmly fixed to the cross member body 9 (see FIG. 5).

The cutout 10d of the reinforcement 10 joined to the cross member body 9 as described above forms a weak area in a vehicle-widthwise intermediate part of the reinforcement 10. In addition, when the collision load equal to or greater than the predetermined value is input to the second cross member 8, the cutout 10d serves to accurately concentrate the collision load on the bead 8e.

As a result, the cutout 10d can reduce concentration of the load at boundaries alone between the cross member body 9 and the vehicle-widthwise opposite ends of the reinforcement 10 extending along the cross member body 9.

In order to accurately concentrate the collision load on the bead 8e when the collision load equal to or greater than the predetermined value is input to the second cross member 8, various conditions such as the width of the cutout 10d, the height of the cutout 10d, and the depth of the cutout 10d are obtained in advance by experiments, simulations, and the like.

According to the embodiment as described above, the vehicle-body lower structure includes the cross member body 9 provided on the upper surface of the floor panel 3 of the vehicle body 2 and extending in the vehicle width direction, and the reinforcement 10 extending along the cross member body 9 in the partial region of the cross member body 9 in the vehicle width direction. The cross member body 9 has the bead 8e extending in the direction intersecting the vehicle width direction in the vehicle-widthwise intermediate position within the partial region in which the reinforcement 10 extends. With these configurations, the vehicle-body lower structure can protect an occupant from the deformation of the vehicle-body side part by controlling the deformation of the cross member 8 against both the barrier side collision and the pole side collision.

That is, the vehicle-body lower structure includes the cross member 8 (second cross member 8) including the cross member body 9 extending in the vehicle width direction and the reinforcement 10 that reinforces the partial region along the cross member body 9 in the vehicle width direction. Furthermore, the cross member body 9 has the bead 8e extending in the direction intersecting the vehicle width direction within the partial region in which the reinforcement 10 extends.

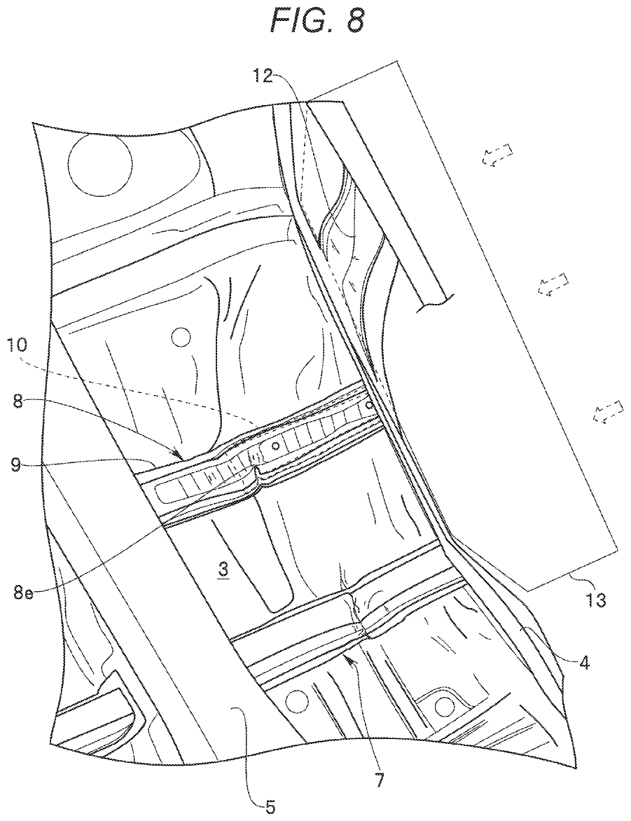

With such a configuration, as illustrated in FIG. 8, the vehicle-body lower structure including the cross member 8 can generate a sufficient reaction against the barrier side collision in which a collision load from a bumper 13 or the like of another vehicle is input to the side surface of the vehicle 1 in a distributed manner.

In one example, the reinforcement 10 reinforces a region in which the collision load is concentrated in the cross member body 9 at an initial collision stage. By the effect of the reinforcement 10, the vehicle-body lower structure can reduce the significant crushing of the cross member 8 at the initial collision stage.

As a result, the vehicle-body lower structure can reduce an entry speed of the door and a structure displacement amount at the time of the barrier side collision. The “structure displacement amount” used herein means, for example, a displacement amount of a side frame including the side sill 4, the center pillar 12, and the like.

The reinforcement 10 is provided in the partial region of the cross member body 9 in the vehicle width direction. This can reinforce the cross member 8 without causing, for example, a significant increase in weight as compared with a configuration in which the reinforcement 10 is provided in the entire region of the cross member body 9 in the vehicle width direction.

In one example, the reinforcement 10 is provided in the vehicle-widthwise outer region of the cross member body 9. As a result, the cross member 8 can efficiently generate a reaction against the collision load at the initial collision stage of the barrier side collision.

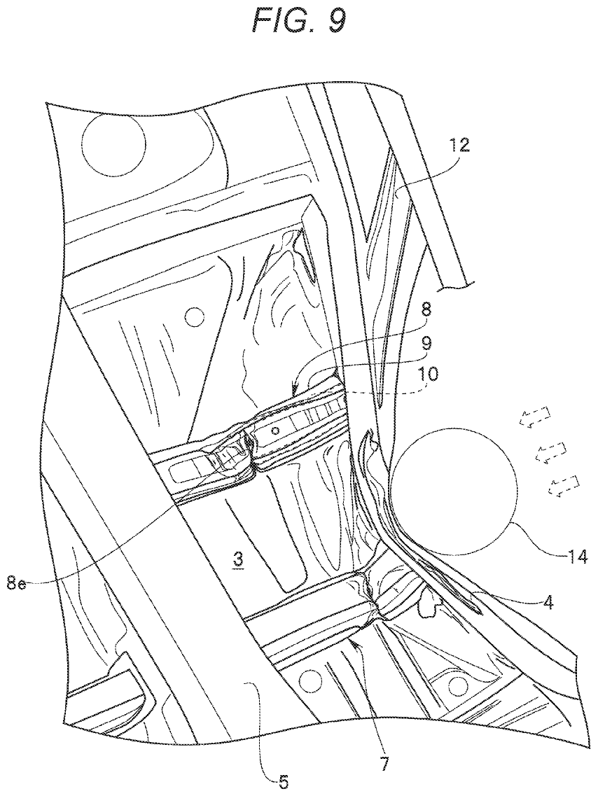

In addition, as illustrated in FIG. 9, the vehicle-body lower structure can generate a sufficient reaction without significant buckling even at the time of a pole side collision in which a utility pole 14 or the like collides with the side surface of the vehicle 1.

In one example, at the time of the pole side collision, a collision load locally larger than that at the time of the barrier side collision is input to the cross member 8. At the time of such a pole side collision, the cross member 8 starts deformation from the bead 8e as a starting point even in the region in which the reinforcement 10 is provided. As a result, the deformation site of the cross member 8 is mainly separated into the boundary region in which the reinforcement 10 is discontinuous and the region in which the bead 8e is provided. Thus, the cross member 8 can generate a sufficient reaction without locally greatly buckling even at the time of the pole side collision. This can reduce the deformation of the floor panel 3 due to the deformation of the cross member 8. For example, this can reduce a deformation such as bending or curling of the floor panel 3 on the rear side with respect to the cross member 8.

At this time, the bead 8e controls a bending direction due to the crushing of the cross member 8. In one example, the bead 8e of the present embodiment is provided on the front vertical wall 8b of the cross member body 9. As a result, the bead 8e generates a starting point of crushing in the front vertical wall 8b of the cross member 8. The starting point of the bead 8e causes the cross member 8 to bend toward the rear side of the vehicle body 2.

This can reduce the deformation such as bending or curling of the rear part of the floor panel 3 even when the cross member 8 is buckled by a large collision load at the time of the pole side collision. That is, since the cross member 8 is buckled toward the rear side of the vehicle body 2, it is possible to prevent the rear part of the floor panel 3 from being pulled toward the front side of the vehicle body 2 when the cross member 8 is buckled. Thus, it is possible to reduce separation of the rear edge of the floor panel 3 from the vehicle body framework, and it is possible to reduce the deformation such as bending or curling of the rear part of the floor panel 3.

With these configurations, the vehicle-body lower structure according to the present embodiment can protect an occupant from the deformation of the vehicle-body side part by controlling the deformation of the cross member 8 against both the barrier side collision and the pole side collision.

In addition, the reinforcement 10 has the cutout 10d at the position corresponding to the bead 8e. The cutout 10d forms the weak area in the vehicle-widthwise intermediate part of the reinforcement 10. Thus, the reinforcement 10 having the cutout 10d can more effectively reduce the concentration of the load on the boundaries between the cross member body 9 and the reinforcement 10 even when the collision load equal to or greater than the predetermined value is input.

In the present embodiment, the example has been described in which the cross member 8 is provided between the side sill 4 and the floor tunnel 5 on the upper surface of the floor panel 3, but the cross member 8 may extend in the vehicle width direction while striding over the floor tunnel 5. Furthermore, in a vehicle type in which the floor tunnel 5 is not formed on the floor panel 3, the cross member 8 may extend over the entire region in the vehicle width direction.

The disclosure described in the embodiment is not limited to the embodiment and various modifications may be made without departing from the scope of the disclosure in the implementation phase. In addition, the embodiment described above includes various stages of the disclosure, and the constituent elements disclosed herein may be appropriately combined to provide various disclosures.

Furthermore, even if some constituent elements described in the embodiment are removed, the resulting components, with the constituent elements removed, can still provide the disclosure, as long as the problems described above can be solved and the effects described above can be achieved.

1. A vehicle-body lower structure comprising:
a cross member body provided on an upper surface of a floor panel of a vehicle body of a vehicle and extending in a vehicle width direction of the vehicle; and
a reinforcement extending along the cross member body in a partial region of the cross member body in the vehicle width direction, wherein
the cross member body has a bead extending in a direction intersecting the vehicle width direction in a vehicle-widthwise intermediate position within the partial region in which the reinforcement extends.

2. The vehicle-body lower structure according to claim 1, wherein the bead is provided on a front vertical wall of the cross member body.

3. The vehicle-body lower structure according to claim 1, wherein the reinforcement has a cutout at a position corresponding to the bead.

4. The vehicle-body lower structure according to claim 1, wherein the reinforcement is disposed in a vehicle-widthwise outer region of the cross member body.

5. The vehicle-body lower structure according to claim 2, wherein the reinforcement is disposed in a vehicle-widthwise outer region of the cross member body.

6. The vehicle-body lower structure according to claim 3, wherein the reinforcement is disposed in a vehicle-widthwise outer region of the cross member body.

7. The vehicle-body lower structure according to claim 2, wherein the bead has a recessed shape that allows the cross member body to be crushed inward in the vehicle width direction when the cross member body is subjected to a side collision.
